(19) United States
(12) Patent Application Publication
(10) Pub. No.: US 2009/0243884 A1
(43) Pub. Date: Oct. 1, 2009

(54) METHOD FOR DISPLAYING TRAFFIC INFORMATION USING PALETTE BASED IMAGE AND DISPLAY APPARATUS USING THE SAME

(76) Inventors: Minseok Kim, Icheon-si (KR); Sanghyun Park, Icheon-si (KR)

Correspondence Address: MCNEELY BODENDORF LLP, P.O. BOX 34175, WASHINGTON, DC, 20043, US

(21) Appl. No.: 12/365,362

(22) Filed: Feb. 4, 2009

(30) Foreign Application Priority Data
Mar. 25, 2008 (KR) 10-2008-0027330

(51) Int. Cl. G08G 1/09

(52) U.S. Cl. 340/905

(57) ABSTRACT

A method and apparatus to display road information are provided. The method includes receiving traffic information, and displaying an image region corresponding to a link identification (ID) by a palette color corresponding to the traffic information on the basis of the received traffic information.

### CROSS-REFERENCE TO RELATED APPLICATION(S)

This application claims the benefit under 35 U.S.C. §119(a) of a Korean Patent Application No. 10-2008-0027330, filed on Mar. 25, 2008 in the Korean Intellectual Property Office, the entire disclosure of which is hereby incorporated by reference.

### TECHNICAL FIELD

The following description relates to a method and apparatus for displaying driving information, and more particularly, to a method and apparatus for displaying road information by matching road speed information with a palette image on a point-to-point basis, and changing a color of a road image of a link identification (ID) into a predetermined color on the basis of speed information of the link ID extracted from received traffic information.

### BACKGROUND

An apparatus and method for providing real-time road information have been developed in light of traffic congestion. A transport protocol expert group (TPEG) is a standard for displaying traffic and travel information by a navigator having, for example, a built-in digital multimedia broadcasting (DMB) receiver, using i.e., a DMB broadcasting network. Unlike a general navigator that provides the shortest distance on a map stored in a terminal, a navigator that provides a TPEG service performs intelligent road guidance based on road and traffic information received in real time over, for example, a terrestrial DMB channel. The TPEG service navigator may display a road condition by color such as ‘blue’ for good condition, ‘orange’ for delay, ‘red’ for congestion and the like, on a navigation map. The TPEG service navigator may inform a driver with the expected traffic circumstances such as traffic speed of a road, allow the driver to make a detour to avoid, for example, a blocked road, and guide the driver with the shortest distance course to a final destination. In addition, the TPEG service navigator may provide information such as dangerous area/road condition information, accident information, restaurant information, trip information and the like.

A method for displaying a blocked road by color by a navigator having a TPEG service includes making and coloring a polygonal road shape. However, this method may require a storage space for a coordinate value database, and by requiring a coordinate value for a road shape, processing speed may slow and coloring for a road type with a link ID cut may become difficult. Another method includes coloring using a flood fill algorithm. The flood fill algorithm is also referred to as a seed fill algorithm and is an algorithm for determining a portion connecting with a specified position in a multiple-dimensional arrangement. The flood fill algorithm may be performed in such a manner that a target color changes into an alternative color following all nodes of an arrangement connecting with a start node. Because the flood fill algorithm may inevitably require a seed coordinate, there is a difficulty in implementing coloring for a road type with a link ID cut. Moreover, the flood fill algorithm may result in slower processing speed.

### SUMMARY

Accordingly, according to an aspect, there is provided a method and apparatus for quickly and simply displaying a speed change of traffic flow.

According to another aspect, there is provided a method for an apparatus to display road information, the method including receiving by the apparatus traffic information, and processing by the apparatus to display an image region corresponding to a link identification (ID) by a palette color corresponding to the traffic information on the basis of the received traffic information.

The processing to display may include extracting speed information corresponding to the link ID from the received traffic information, selecting a palette color matched to the extracted speed information, and changing a color of the image region into the selected palette color.

The method may further include storing the link ID and the selected palette color in a storage unit of the apparatus.

The traffic information may be received in real time.

The received traffic information may be transport protocol expert group (TPEG) data based on a TPEG protocol.

According to still another aspect, there is provided an apparatus to display road information, the apparatus including a receiver to receive traffic information, a speed information extractor to extract speed information of a link identification (ID) from the received traffic information, a palette color selector to select a palette color matched to the extracted speed information, and a display unit to change a color of an image region corresponding to the link ID into the selected palette color and to display the image region.

The apparatus may further include a storage unit to store the link ID and the selected palette color for the link ID.

The traffic information may be received in real time.

The received traffic information may be TPEG data based on a TPEG protocol.

The apparatus may be a navigation unit to provide driving information.

The link ID may correspond to a region having a starting point and an ending point, and the speed information may correspond to an average driving speed of the region.

Other features will become apparent to those skilled in the art from the following detailed description, which, taken in conjunction with the attached drawings, discloses exemplary embodiments.

### BRIEF DESCRIPTION OF THE DRAWINGS

FIG. 1 is a block diagram illustrating a construction of an apparatus to display road information according to an exemplary embodiment.

FIG. 2 is a diagram illustrating link identifications (IDs) around a river and a structure of a database therefor according to an exemplary embodiment.

FIG. 3 is a flow diagram illustrating a method for displaying road information according to an exemplary embodiment.

Throughout the drawings and the detailed description, unless otherwise described, the same drawing reference numerals will be understood to refer to the same elements, features, and structures. The elements may be exaggerated for clarity and convenience.

### DETAILED DESCRIPTION

The following detailed description is provided to assist the reader in gaining a comprehensive understanding of the methods, apparatuses and/or systems described herein. Accordingly, various changes, modifications, and equivalents of the systems, apparatuses and/or methods described herein will be suggested to those of ordinary skill in the art. Also, descriptions of well-known functions and constructions are omitted to increase clarity and conciseness.

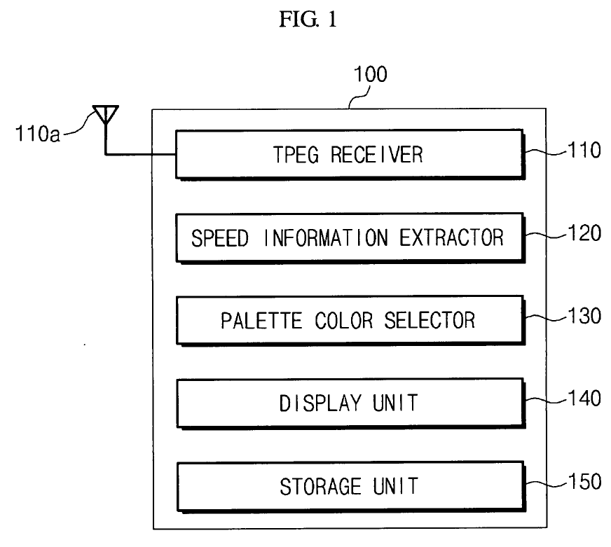

FIG. 1 illustrates a construction of an apparatus 100 to display road information according to an exemplary embodiment. The apparatus 100 includes a transport protocol expert group (TPEG) receiver 110 including an antenna 110a, a speed information extractor 120, a palette color selector 130, a display unit 140, and a storage unit 150.

The TPEG receiver 110 receives traffic information from an external source through the antenna 110a. The received traffic information is forwarded to the speed information extractor 120. The traffic information is, for example, TPEG data based on a TPEG protocol. The traffic information includes a link identification (ID) and traffic information ID including speed information (e.g., an average car speed) of the link ID.

The speed information extractor 120 extracts a link ID and speed information by link ID from the traffic information forwarded from the TPEG receiver 110. The speed information extracted by link ID is forwarded to the palette color selector 130.

The palette color selector 130 selects a palette color that corresponds to the speed information forwarded from the speed information extractor 120. For example, where the extracted link ID is equal to ‘10005’ and the speed information is equal to ‘300001’, a palette color of a region corresponding to the link ID is changed into ‘orange,’ thus illustrating that there is a delay or congestion. This is only exemplary and it is understood that palette colors may be selected to reflect a variety of road circumstances. The selected palette color is forwarded to the display unit 140.

The display unit 140 changes a color of a displayed image region corresponding to the link ID into a palette color forwarded from the palette color selector 130, and displays the image region.

The storage unit 150 stores the link ID and the palette color selected for the link ID.

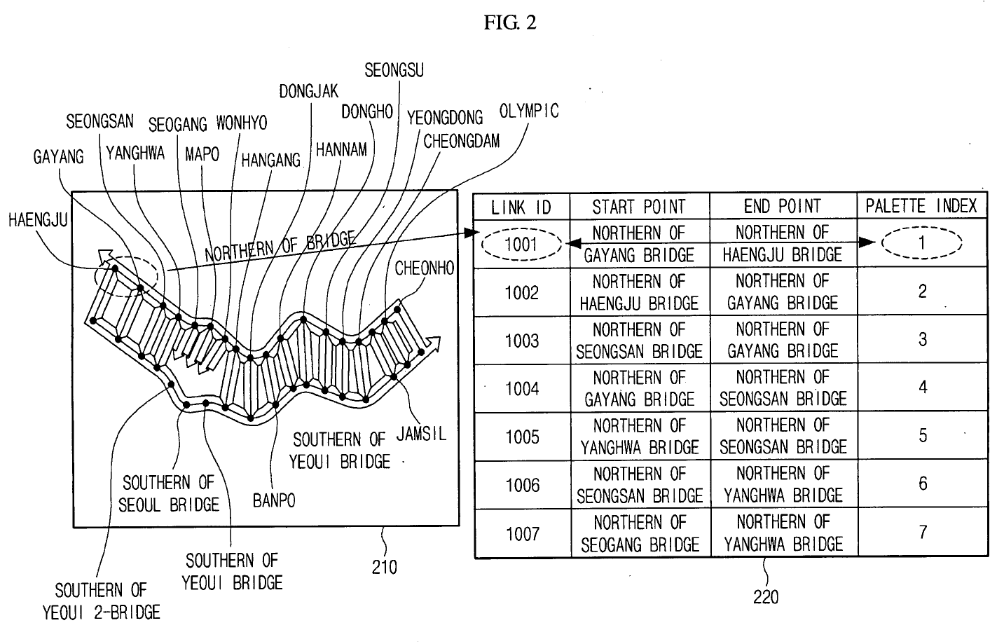

FIG. 2 illustrates link IDs around a river, for example, a portion of the Han river near Seoul, Republic of Korea, and a structure of a database 220 therefor according to an exemplary embodiment.

As shown in FIG. 2, where a link ID is equal to ‘1001’, a start point is the northern end of the Gayang bridge and an end point is the northern end of the Haengju bridge. Link IDs and palette indexes representing palette colors may be matched with each other on a point-to-point basis in the storage unit 150. The palette index is constructed to have a different value depending on speed information extracted from received traffic information. Accordingly, a color of an image region of a road corresponding to the link ID ‘1001’ from the northern end of the Gayang bridge to the northern end of the Haengju bridge may be changed by changing the palette index representing the palette color. And the result may be displayed in a display 210.

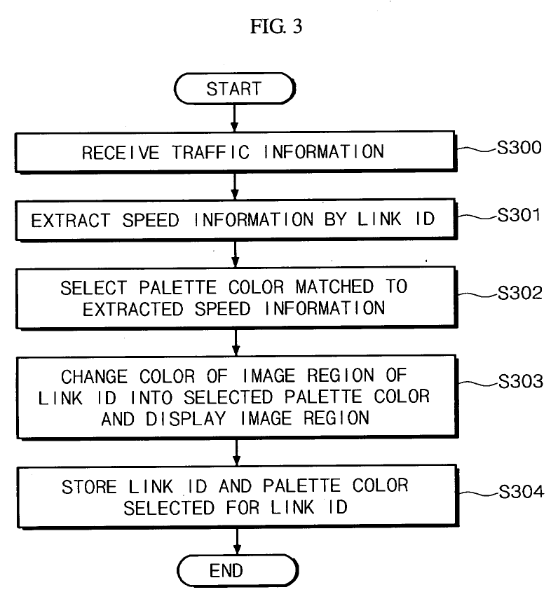

FIG. 3 illustrates a method for displaying road information according to an exemplary embodiment.

Referring to FIGS. 1 and 3, in operation S300, the TPEG receiver 110 receives traffic information from an external source through the antenna 110a. The received traffic information is forwarded to the speed information extractor 120.

In operation 301, the speed information extractor 120 extracts a link ID and speed information corresponding to the link ID from the traffic information forwarded from the TPEG receiver 110. The extracted speed information is forwarded to the palette color selector 130.

In response to receiving the speed information forwarded from the speed information extractor 120, in operation 302, the palette color selector 130 selects a palette color that is matched, for example, on a point-to-point basis to the speed information.

In operation 303, the display unit 140 changes a color of a displayed image region corresponding to the link ID into a palette color forwarded from the palette color selector 130 and displays the image region.

In operation 304, the storage unit 150 stores the link ID and the palette color selected for the link ID.

The methods described above may be recorded, stored, or fixed in one or more computer-readable media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for an apparatus to display road information, the method comprising:
receiving by the apparatus traffic information; and
processing by the apparatus to display an image region corresponding to a link identification (ID) by a palette color corresponding to the traffic information on the basis of the received traffic information.

2. The method of claim 1, wherein the processing to display the image region comprises:
extracting speed information corresponding to the link ID from the received traffic information;
selecting a palette color matched to the extracted speed information; and
changing a color of the image region into the selected palette color.

3. The method of claim 2, further comprising storing the link ID and the selected palette color in a storage unit of the apparatus.

4. The method of claim 1, wherein the traffic information is received in real time.

5. The method of claim 1, wherein the received traffic information is transport protocol expert group (TPEG) data based on a TPEG protocol.

6. A computer-readable storage medium for storing a program to display road information, comprising instructions to cause a computer to:
receive traffic information; and
process to display an image region corresponding to a link identification (ID) by a palette color corresponding to the traffic information on the basis of the received traffic information.

7. An apparatus to display road information, the apparatus comprising:
a receiver to receive traffic information;
a speed information extractor to extract speed information of a link identification (ID) from the received traffic information;
a palette color selector to select a palette color matched to the extracted speed information; and
a display unit to change a color of an image region corresponding to the link ID into the selected palette color and to display the image region.

8. The apparatus of claim 7, further comprising a storage unit to store the link ID and the selected palette color for the link ID.

9. The apparatus of claim 7, wherein the traffic information is received in real time.

10. The apparatus of claim 7, wherein the received traffic information is transport protocol expert group (TPEG) data based on a TPEG protocol.

11. The apparatus of claim 7, wherein the apparatus is a navigation unit to provide driving information.

12. The apparatus of claim 7, wherein:
the link ID corresponds to a region having a starting point and an ending point, and
the speed information corresponds to an average driving speed of the region.
